(19) United States
(12) Patent Application Publication
(10) Pub. No.: US 2010/0213418 A1
(43) Pub. Date: Aug. 26, 2010

(54) Method Of Starting A Fuel Processor

(76) Inventors: William Allison Logan, Vancouver (CA); Andre Boulet, Vancouver (CA); Xuantian Li, Richmond (CA)

Correspondence Address: MCANDREWS HELD & MALLOY, LTD, 500 WEST MADISON STREET, SUITE 3400, CHICAGO, IL, 60661, US

(21) Appl. No.: 12/708,781

(22) Filed: Feb. 19, 2010

Related U.S. Application Data
(60) Provisional application No. 61/154,292, filed on Feb. 20, 2009.

(51) Int. Cl. C01B 3/38

(52) U.S. Cl. 252/373

(57) ABSTRACT

In methods for starting a fuel processor, the equivalence ratio of reactants supplied to the fuel processor is controlled in a step-wise procedure to rapidly heat the fuel processor, and optionally sustain it within a desired temperature range until a hydrogen-containing gas stream is needed.

### CROSS-REFERENCE TO RELATED APPLICATIONS

This application is related to and claims priority benefits from U.S. Provisional Patent Application Ser. No. 61/154,292, entitled “Method of Starting a Fuel Processor”, filed on Feb. 20, 2009, which is hereby incorporated by reference in its entirety.

### FIELD OF THE INVENTION

The present technology relates to methods for starting a fuel processor for producing a hydrogen-containing gas stream, such as a syngas stream. The present methods are particularly suitable for fuel processors that are used in engine system applications.

### BACKGROUND OF THE INVENTION

For engine systems in vehicular or other mobile applications where a supply of hydrogen is utilized, due to challenges related to on-board storage of a secondary fuel and the current absence of a hydrogen refueling infrastructure, hydrogen is preferably generated on-board using a fuel processor. The hydrogen-containing gas from the fuel processor can be used to regenerate, desulfate and/or heat engine exhaust after-treatment devices, can be used as a supplemental fuel for the engine, and/or can be used as a fuel for a secondary power source, for example, a fuel cell. In some applications the demand for the hydrogen-containing gas produced by the fuel processor is highly variable.

One type of fuel processor is a syngas generator (SGG) that can convert a fuel reactant into a gas stream containing hydrogen (H₂) and carbon monoxide (CO), known as syngas. Air and/or a portion of the engine exhaust stream can be used as an oxidant reactant for the fuel conversion process. Steam and/or water can optionally be added. The SGG can be conveniently supplied with a fuel comprising the same fuel that is used to operate the engine. Alternatively a different fuel can be used, although this would generally involve a separate secondary fuel source and supply system specifically for the SGG. The syngas can be beneficial in processes used to regenerate exhaust after-treatment devices. For other applications, for example, use as a fuel in a fuel cell, the syngas stream can be additionally processed prior to use.

The thermochemical conversion of a hydrocarbon fuel to syngas is performed in an SGG at high operating temperatures with or without the presence of a suitable catalyst. Parameters including equivalence ratio (ER) and operating (reaction) temperature are typically adjusted in an attempt to increase the efficiency of the fuel conversion process while reducing the generally undesirable formation of carbon (coke or soot) and other deposits, which can cause undesirable effects within the SGG and/or in downstream components. The term equivalence ratio (ER) herein refers to a ratio between the actual amount of oxygen supplied and the theoretical stoichiometric amount of oxygen which would be required for complete combustion of the fuel. An ER of greater than 1 represents a fuel lean mode (excess oxygen), while an ER of less than 1 represents a fuel rich mode (excess fuel). The term carbon herein includes solid fraction particulates of carbon including amorphous carbon, coke and soot, as well as carbonaceous gums, resins and other deposits. Over time, carbon accumulation can impede the flow of gases, increase the pressure drop across the SGG and its associated components, and reduce the operating life or durability of the SGG. Large accumulations of carbon also have the potential to create excessive amounts of heat that can damage the SGG if the carbon is converted (for example, combusted or oxidized) in an uncontrolled manner, for example, in a short period of time.

While many have attempted to eliminate or reduce carbon formation, practically there is an inevitable tendency for carbon to form during the conversion of the fuel into syngas. A particulate filter, also known as a particulate trap, soot filter or soot trap, can be employed at least partially within or downstream of a fuel processor to collect or trap carbon. This allows for increased control and management of the particulates. The particulate filter can be, for example, a wall-flow monolith, a fibrous structure, a foam structure, a mesh structure, an expanded metal type structure or a sintered metal type structure. The particulate filter can be constructed from a suitable material, for example, ceramic materials, and can optionally contain one or more catalysts. Typically, carbon can be allowed to collect until the accumulation begins to adversely affect the gas flow across the particulate filter. A subsequent carbon removal or conversion process (for example, combustion, oxidation or gasification) can be initiated to remove the carbon particulates collected by the particulate filter. A carbon removal process can be used to regenerate the filter in situ from time to time, and then it will continue to trap carbon particulates.

In some applications including, for example, an exhaust after-treatment assembly in an engine system, the demand for a syngas stream can occur in a short period of time, once the engine has started. Some particular challenges associated with the operation of fuel processors for vehicular or other mobile applications can include increasing the temperature of the fuel processor above a desired threshold in a short period of time.

### SUMMARY OF THE INVENTION

A method of starting a fuel processor to produce a syngas stream comprising hydrogen and carbon-monoxide from a fuel reactant stream and an oxygen-containing reactant stream, comprises:
(a) supplying the fuel reactant stream and the oxygen-containing reactant stream to the fuel processor at a first equivalence ratio to ignite the combined fuel and oxygen-containing reactant streams;
(b) supplying the fuel reactant stream and the oxygen-containing reactant stream to the fuel processor at a second equivalence ratio to heat the fuel processor until a threshold temperature is reached; and
(c) supplying the fuel reactant stream and the oxygen-containing reactant stream to the fuel processor at a third equivalence ratio to produce the syngas stream.

Preferably the second equivalence ratio is higher than the first and third equivalence ratios. In some embodiments of the method the third equivalence ratio is substantially the same as the first equivalence ratio. For example, the first and third equivalence ratios can be less than 1, and the second equivalence ratio can be about 1.

The fuel processor can optionally be held in a “stand-by mode” between steps (b) and (c), for example, until there is demand for a syngas stream. This can be accomplished by supplying the fuel reactant stream and the oxygen-containing reactant stream to the fuel processor at a standby equivalence ratio, or alternating between the second and a standby equivalence ratio, to maintain the fuel processor within a desired temperature range. Preferably the standby equivalence ratio is higher than the second equivalence ratio. For example, the second equivalence ratio can be about 1 and the standby equivalence ratio can be greater than 1.5.

In some embodiments of the starting method the supply of the fuel reactant stream to said fuel processor is started prior to starting the supply of the oxygen-containing reactant stream to said fuel processor.

Embodiments of the starting method can optionally further comprise pre-heating at least one of the reactant streams, for example, by directing one or both of them through a heat exchanger coupled to the fuel processor such that heat from the fuel processor is transferred to the reactant stream.

The above-described methods are particularly suitable for non-catalytic fuel processors.

### BRIEF DESCRIPTION OF THE DRAWINGS

FIG. 1 is a flowchart of an embodiment of a start-up process for a syngas generator (SGG).

FIG. 2 is a simplified graph (not necessarily to scale) illustrating examples of equivalence ratios (ER) and temperature of a syngas generator (SGG), over time during a start-up process of the SGG shown in FIG. 1.

FIG. 3 is a flowchart of an embodiment of a start-up process with an optional stand-by mode for a syngas generator (SGG).

FIG. 4 is a graph (not necessarily to scale) illustrating examples of equivalence ratios (ER) and temperature of a syngas generator (SGG), over time during a start-up process of the SGG shown in FIG. 3.

FIG. 5 is a flow chart showing details of an embodiment of an ignition step in a start-up process for a fuel processor.

FIG. 6 is a simplified graph (not necessarily to scale) illustrating examples of reactant (fuel and air) mass flow rates and temperature of an SGG over time during a start-up process for a fuel processor.

### DETAILED DESCRIPTION OF PREFERRED EMBODIMENT(S)

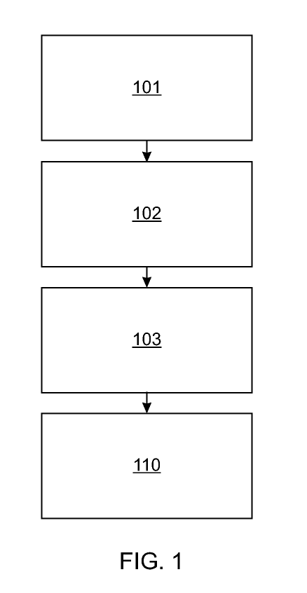

In preferred methods of starting a fuel processor, the fuel processor employs a multi-step process. FIG. 1 is a flow chart illustrating an example start-up process for an SGG. The flow chart starts with the SGG in an “off” or non-operating state. In step 101, the reactants are supplied to the fuel processor at a first equivalence ratio (ER) value which enables ignition of the supplied fuel and oxidant reactant streams. More preferably the first ER value enables ignition of the combined reactant stream with a low ignition energy (amount of energy required for ignition to occur). Preferably the first ER value is substantially below 1 (stoichiometric). The first ER value can be maintained, for example, for a first period in order for ignition of the combined reactant stream to occur (for example, up to 10 seconds) and/or until a particular sensed temperature or stable flame has been achieved.

The fuel reactant and oxidant reactant streams are preferably combined and mixed prior to ignition. Ignition of the combined reactant stream can be initiated with an ignition device including, for example, glow plug, resistive wire, or spark plug. As step 101 is completed, the process continues with step 102 where the ER can be adjusted to a second ER value which is at or slightly below stoichiometric. Combustion of the fuel at this second ER value provides a hot gas stream that rapidly raises the temperature of the SGG to a desired temperature for a potential subsequent fuel conversion process at a lower ER. The second ER value can be maintained, for example, until a specific time period has passed or until the SGG exceeds a threshold temperature, or is controlled to produce a syngas stream, or is controlled to shut-down.

Some syngas can be produced during step 101, during the transition between step 101 and 102, and even during step 102 depending on the exact value of the second ER, but the primary function of step 102 is to raise the operating temperature of the SGG. Optionally, step 102 can comprise a series of incremental or oscillating ER values. After step 102, the start-up process can be completed in step 103 where the ER can be adjusted to a third ER value which enables the production of a syngas stream and a desired operating condition of the SGG. Once step 103 has commenced, the start-up process is complete. The multi-step process offers the advantage of reducing the time for the SGG to reach a desired temperature for production of a syngas stream.

In some embodiments the first and third ER values are about the same. In other embodiments they are both about 0.5 when diesel is employed as a fuel reactant.

In some operating embodiments, in order to intentionally produce additional carbon for future conversion, the SGG can be advantageously operated at a richer or lower ER for a brief period prior to shut-down, in optional step 110. For example, when diesel is employed as a fuel reactant, operating with an ER in the range of 0.2-0.4 typically results in some carbon formation. The carbon produced and collected within the SGG during the shut-down period is then available for conversion to syngas during the successive start-up of the SGG; for example, during step 102 of a subsequent start-up process or in an additional step. Other parameters including for example, the temperature of the SGG, can also be adjusted to intentionally produce additional carbon. A device such as, for example, a particulate filter can be employed within an SGG to collect the carbon in the syngas stream.

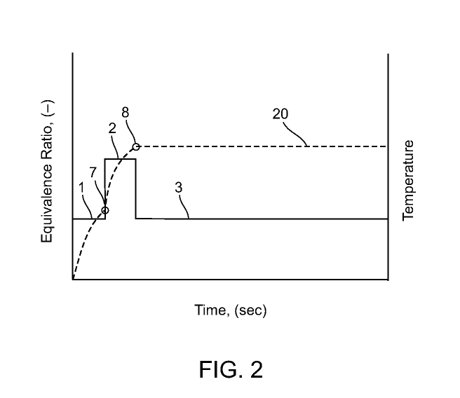

FIG. 2 is a simplified graph (not necessarily to scale) illustrating examples of equivalence ratios (ER) and temperature of a syngas generator (SGG) over time during a start-up process of the SGG. In FIG. 2, solid line 1 shows the first ER value of step 101; solid line 2 shows the second ER value of step 102; and solid line 3 shows the third ER value of step 103. Dashed line 20 shows the temperature profile over time. First ER value 1 results in a temperature (shown at point 7) of temperature plot 20 that corresponds to the temperature of the combined reactant stream after it has been ignited. At second ER value 2 the temperature rises until it is within a desired range (shown at point 8) of temperature plot 20 that corresponds to a combustion temperature of the combined reactant stream. At third ER value 3 the temperature remains substantially within the desired range, or is held in a desired range by subsequent adjustments to the ER (not shown in FIG. 2) and/or other operating conditions. Solid line 1 or the first ER value is about the same value as solid line 3 or the third ER value, but can optionally be different.

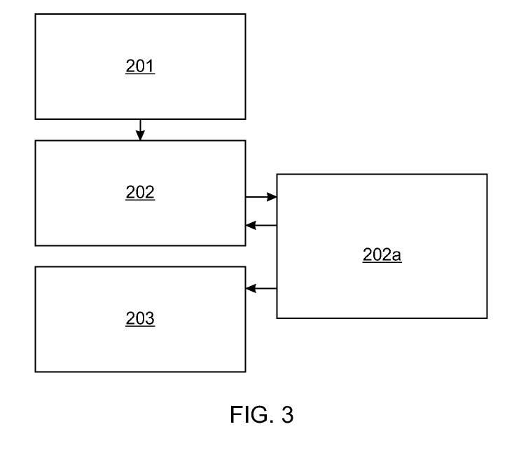

FIG. 3 is a flowchart of an example start-up process with an optional stand-by mode for a syngas generator (SGG). The flow chart starts with the SGG in an “off” or non-operating state. In step 201, the reactants are supplied to the fuel processor at a desired predetermined first ER value which enables ignition of the supplied fuel and oxidant reactant streams as described above for step 101. As step 201 is completed, the process continues with step 202 where the ER can be adjusted to a second ER value is at or slightly below stoichiometric. Combustion of the fuel at this ER provides a hot gas stream that rapidly raises the temperature of the SGG to a desired temperature for a potential subsequent fuel conversion process at a lower ER. The second ER value can be maintained until a specific time period has passed or until the SGG, for example, exceeds a threshold temperature. If at that point there is no demand for syngas, the SGG can be operated in a stand-by mode that maintains the temperature of the SGG within a desired temperature range. This can involve adjusting the ER in step 202a to a standby ER value, or adjusting it back and forth one or more times between the second ER value and a standby ER value, by cycling between steps 202 and 202a. The standby ER value is preferably substantially greater than 1 (lean) so that the fuel processor does not overheat (which it would tend to do if the SGG was operated for a long period at the second ER value) while the mass flow of the fuel or both reactants can be reduced in step 202a, which can further result in reducing the consumption of fuel and/or electrical power (for example, to supply the oxidant stream). The leaner reactant stream can thus be used to regulate the temperature in stand-by mode. In some embodiments the standby ER value is about 1.5 to 1.8 when diesel is employed as a fuel reactant.

During the stand-by mode, the ER can be adjusted back and forth between the second and standby values based on a monitored parameter, such as temperature, or on a time basis, for example at a particular frequency. Operation in the standby mode (step 202a or cycling between steps 202 and 202a) can continue, for example, until syngas production is required or a shut-down of the SGG is initiated. When there is demand for a syngas stream, step 203 is initiated where the ER can be adjusted to a third ER value which enables the production of a syngas stream and a desired operating condition of the SGG. Once step 203 has commenced, the start-up process is complete. Again, in some embodiments during steps 201 and 203, the first and third ER values are about the same. In some embodiments they are both about 0.5 when diesel is employed as a fuel reactant. Such a multi-step process offers the advantage of reducing the time for the SGG to reach a desired temperature for production of a syngas stream, while the stand-by mode enables the SGG to be maintained within a desired temperature range prior to the production of a syngas stream. Optionally, in order to provide additional carbon for future conversion (for example, by combustion, oxidation or gasification) during the start-up method, the SGG can be advantageously operated at a richer or lower ER for a brief period prior to shut-down. For example, when diesel is employed as a fuel reactant, operating with an ER in the range of 0.2-0.4 typically results in some carbon formation. The carbon produced and collected within the SGG during the shut-down period or process is then available for conversion to syngas during the successive start-up of the SGG. Other parameters including for example, the temperature of the SGG, can also be adjusted to intentionally produce additional carbon. A device including, for example, a particulate filter can be employed within an SGG to collect the carbon in the syngas stream.

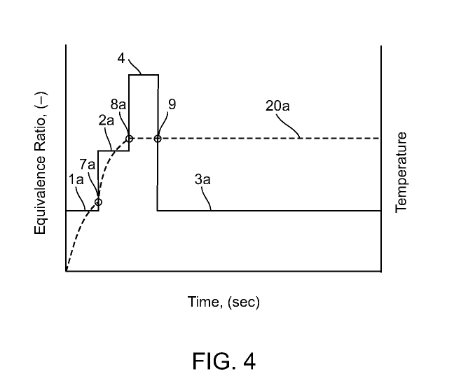

FIG. 4 is a simplified graph (not necessarily to scale) illustrating examples of equivalence ratios (ER) and temperature of a syngas generator (SGG) over time during a start-up process of the SGG. In FIG. 4, solid line 1a shows the first ER value of step 201; solid line 2a shows the second ER value of step 202; and solid line 3a shows the third ER value of step 203. Dashed line 20a shows the temperature profile over time. First ER value 1a results in a temperature (shown at point 7a) of temperature plot 20a that corresponds to the temperature of the combined reactant stream after it has been ignited. At second ER value 2a the temperature rises until it is within a desired range (shown at point 8a) of temperature plot 20a that corresponds to a combustion temperature of the combined reactant stream. At standby ER value 4 the temperature remains substantially within the desired range (shown, for example, at point 9 of temperature plot 20a). At third ER value 3a the temperature remains substantially within the desired range, or is held in a desired range by subsequent adjustments to the ER (not shown in FIG. 4) and/or other operating conditions. Solid line 1a or the first ER value is about the same value as solid line 3a or the third ER value, but can optionally be different.

Once the fuel processor has been started it can be operated in various ways, depending on the application and the demand for syngas, among other things. In some cases the ER can be adjusted and varied following steps 103 (in FIG. 1) or 203 (in FIG. 2), in accordance with syngas demand or other factors. In other cases the third ER can be sustained at a substantially constant value in steps 103 (in FIG. 1) or 203 (in FIG. 2) until demand for the syngas stream ceases. For example, once started an SGG can be operated to produce syngas for a prolonged period of time with the reactants supplied at a substantially constant ER. A prolonged period of time can be, for example, greater than about a few minutes and in some embodiments up to at least several hours. A “substantially constant” ER herein refers to an equivalence ratio that is sustained within a narrow range, for example, within ±0.1 or preferably ±0.05 of a particular value. Preferably the substantially constant equivalence ratio is substantially below 1 (stoichiometric). In some embodiments it is about 0.5 when diesel is employed as a fuel reactant.

In embodiments of the above-described methods of starting a fuel processor, the second step is commenced once ignition of the combined reactant stream has occurred (for example, in step 101 in FIG. 1 or in step 201 in FIG. 2). The length of time taken for ignition varies depending on a number of factors, however it has been found that the time-to-ignition can be reduced, and the overall starting process beneficially accelerated. For example, in some systems starting the flow of the fuel reactant stream to the fuel processor prior to starting the flow of the oxygen-containing reactant stream can reduce the time to ignition, as described in more detail below. Furthermore, in some systems activating the ignition device (for example, a glow plug) prior to starting the flow of either of the reactant streams to the fuel processor can reduce the time-to-ignition. Using one or both of these techniques can reduce the time-to-ignition and the overall start-up time by a few seconds up to at about 30 seconds.

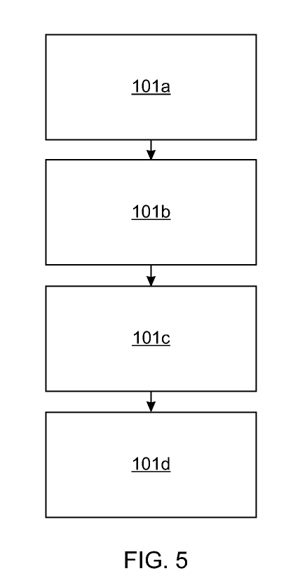

FIG. 5 is a flow chart showing details of an embodiment of an ignition step (for example, step 101 in FIG. 1) in a start-up process for a fuel processor. The flow chart starts with the SGG in an “off” or non-operating state. In step 101a, an ignition device is activated, for example, current is supplied to a glow plug. In step 101b supply of a fuel reactant stream is started at an initial mass flow rate (for example, by starting a fuel pump). Steps 101a and 101b can occur simultaneously, but preferably the ignition device is activated first in step 101a and then, once the ignition device is determined to be ready or after a fixed period of time, supply of the fuel reactant stream is started in step 101b. After a short delay, supply of an oxygen-containing reactant stream is commenced in step 101c, (for example, by activating an air pump). In optional step 101d, the mass flow rate of the fuel is adjusted. Step 101d can occur simultaneously with step 101c, or just before or just after step 101c. For example, as the supply of the oxygen-containing reactant stream has started, the fuel flow rate can be reduced to a mass flow rate that will provide an ER of about 0.5 once the oxygen-containing reactant stream reaches its operational mass flow rate. While the mass flow rate of the oxygen-containing reactant stream is ramping up the ER will be lower. Step 101d can be omitted depending, for example, on the temperature in the SGG. In subsequent (post-ignition) steps of the start-up process (for example, steps 102 and 103 in FIG. 1; and steps 202, 202a and 203 in FIG. 2), the ER is further adjusted as described above.

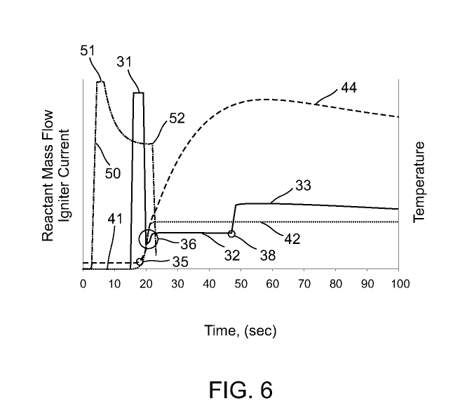

FIG. 6 is a simplified graph (not necessarily to scale) illustrating examples of reactant (fuel and air) mass flow rates and temperature of an SGG over time during a start-up process. In the example illustrated in FIG. 6, supply of a fuel reactant stream to the fuel processor is initiated at about 15 seconds, for example, by activating a fuel supply pump or subsystem (for example, in step 101a in FIG. 5). The solid line shows the fuel reactant stream mass flow rate, with portion 31 showing the initial fuel reactant stream mass flow rate. In some embodiments, this initial fuel mass flow rate is chosen to be considerably higher than the fuel mass flow rate(s) used during subsequent operation of the fuel processor, for reasons described in more detail below. After a few seconds, supply of an air stream to the fuel processor is initiated (at point 35 in FIG. 6), for example, by activating an air supply pump or subsystem (for example, in step 101b in FIG. 5). The dotted line shows the air stream mass flow rate. The air stream mass flow rate gradually ramps up to an operating mass flow rate shown in portion 42. At approximately the same time as the supply of air is started, the fuel mass flow rate is decreased (at point 36, then as indicated by portion 32 of the solid line). Dashed line 44 shows the SGG temperature. The reactants ignite almost immediately, as indicated by the rapid increase in temperature. The fuel mass flow rate is indicated by portion 32 of the solid line provides an ER value at which combustion of the combined reactant stream further heats the SGG, as indicated by the continued increase in temperature profile 44 over portion 32 of the solid line (showing fuel mass flow rate). This corresponds, for example, to step 102 in FIG. 1 and step 202 in FIG. 2. In the example illustrated in FIG. 6, optional step 101d from FIG. 5 is omitted, and the ER for this stage is approximately 0.9. Once the SGG temperature reaches a desired value or after a specific time period has passed, at point 38 the ER is adjusted to a lower value by increasing the fuel reactant stream mass flow rate, as shown in portion 33 of the solid line. This step corresponds, for example, to step 103 in FIG. 1 and step 203 in FIG. 2, and completes the start-up process. A syngas stream is produced for a period of time, and the temperature remains substantially within a desired range (not shown in FIG. 6), or is held in a desired range by subsequent adjustments to the ER (not shown in FIG. 6) and/or other operating conditions.

The electrical current drawn by an ignition device is also shown in FIG. 6 by dot-dashed line 50. The ignition device can optionally be activated before the supply of either reactant stream is started. In the example illustrated in FIG. 6, the ignition device is activated about 10 seconds before supply of the fuel reactant stream is initiated. This time delay (for example, between steps 101a and 101b in FIG. 5) can be shorter or longer, depending on how long it takes for the particular ignition device that is being used to warm up or become operational. The ignition device draws a high current initially (as indicated by portion 51 of dot-dashed line 50) until it reaches its operating temperature, then the current draw subsides. After ignition of the combined reactant stream has occurred and the SGG temperature has reached the auto-ignition temperature of the combined reactant stream (typically between 400° C. and 600° C.) the ignition device can be turned off, as indicated at point 52 of dot-dashed line 50.

A fuel supply subsystem for an SGG typically includes a fuel pump; pump ancillary devices such as a pulsation dampener; at least one conduit; and a fuel delivery nozzle. The fuel pump typically has variable flow output and is typically sized to provide a suitable fuel mass flow rate range for the SGG. A pulsation dampener is often included downstream of the pump outlet in order to provide a steady flow of fuel, with reduced pulsation. The fuel pump, the dampener, the conduits and the nozzle have internal volumes which are substantially filled with fuel during operation of the fuel processor. When the internal volume of the fuel supply subsystem contains no fuel or is not filled with fuel, which can be the case prior to start-up, there will be a time lag between activating the fuel pump and fuel reaching the outlet of the fuel injection nozzle. To provide a rapid start-up, it is beneficial to know the time lag associated with filling a particular fuel supply subsystem. The length of the time lag associated with filling a fuel supply subsystem with fuel can be reduced by running the fuel pump at an initial mass flow rate that is considerably higher than the fuel mass flow rate(s) used during subsequent operation of the fuel processor, for example, as indicated by portion 31 of the solid line in FIG. 6.

An air supply subsystem for an SGG typically consists of an air blower or an air mass flow controller. The air supply subsystem typically also includes at least one conduit and an air supply nozzle. The air supply subsystem is typically sized to provide a suitable air mass flow for operating the SGG, and can have variable flow output or not. When the air supply is activated, the air mass flow ramps up to the operating air mass flow rate over a period of time, for example 10 seconds. To provide a rapid start-up, it is beneficial to know the length of the ramp-up time associated with starting a particular air supply subsystem, and the relative percentage of maximum air output over the ramp-up time. The relative timing of steps 101b (starting fuel supply) 101c (starting air stream supply) in FIG. 5 can be important in reducing the time-to-ignition. In some embodiments, the delay between step 101ba and step 101c is chosen to be such that the air mass flow rate will be about 10% of its operating value (dotted line 42 in FIG. 6) when the fuel reactant stream reaches the SGG.

In preferred embodiments of the present methods for starting operation of a fuel processor to produce a syngas stream, the fuel processor is a non-catalytic partial oxidation syngas generator. The present methods could however offer advantages in other types of fuel processors, reformers or reactors operating on different types of reactant mixtures. For example, the fuel processor could be of various types, such as a catalytic partial oxidizer, a non-catalytic partial oxidizer, and/or an autothermal reformer.

The fuel supplied to the fuel processor can be a liquid fuel (herein meaning a fuel that is a liquid when under IUPAC defined conditions of standard temperature and pressure) or a gaseous fuel. Suitable liquid fuels include, for example, diesel, gasoline, kerosene, liquefied natural gas (LNG), fuel oil, methanol, ethanol or other alcohol fuels, liquefied petroleum gas (LPG), or other liquid fuels from which hydrogen can be derived. Alternative gaseous fuels include natural gas and propane. Fuels can include oxygenated fuels. In preferred embodiments of the present method the fuel reactant stream comprises diesel.

The fuel processor can be deployed in various end-use mobile or stationary applications where a hydrogen-consuming device is employed. The product syngas stream can be directed to one or more hydrogen-consuming devices for example an exhaust after-treatment device, a fuel cell, or an engine.

While particular elements, embodiments and applications of the present technology have been shown and described, it will be understood, that the invention is not limited thereto since modifications can be made by those skilled in the art without departing from the scope of the present disclosure, particularly in light of the foregoing teachings.

What is claimed is:

1. A method of starting a fuel processor to produce a syngas stream comprising hydrogen and carbon-monoxide from a fuel reactant stream and an oxygen-containing reactant stream, said method comprising:
(a) supplying said fuel reactant stream and said oxygen-containing reactant stream to said fuel processor at a first equivalence ratio to ignite said combined fuel and oxygen-containing reactant streams;
(b) supplying said fuel reactant stream and said oxygen-containing reactant stream to said fuel processor at a second equivalence ratio to heat said fuel processor until a threshold temperature is reached; and
(c) supplying said fuel reactant stream and said oxygen-containing reactant stream to said fuel processor at a third equivalence ratio to produce said syngas stream.

2. The method of claim 1 wherein said fuel processor is a non-catalytic fuel processor.

3. The method of claim 1 wherein said second equivalence ratio is higher than said first and third equivalence ratios.

4. The method of claim 1 wherein third equivalence ratio is substantially the same as said first equivalence ratio.

5. The method of claim 1 wherein said first and third equivalence ratios are less than 1, and said second equivalence is about 1.

6. The method of claim 2 further comprising in step (c) sustaining said third equivalence ratio at a substantially constant value until demand for said syngas stream ceases.

7. The method of claim 2 wherein in between steps (b) and (c) said fuel processor is operated in a stand-by mode until there is demand for said syngas stream, by supplying said fuel reactant stream and said oxygen-containing reactant stream to said fuel processor at a standby equivalence ratio to maintain said fuel processor within a desired temperature range.

8. The method of claim 7 wherein said second equivalence ratio is about 1 and said standby equivalence ratio is greater than 1.

9. The method of claim 8 wherein said standby equivalence ratio is greater than 1.5.

10. The method of claim 2 wherein in between steps (b) and (c) said fuel processor is operated in a stand-by mode until there is demand for said syngas stream, by alternately supplying said fuel reactant stream and said oxygen-containing reactant stream to said fuel processor at said second equivalence ratio and a standby equivalence ratio to maintain said fuel processor within a desired temperature range.

11. The method of claim 10 wherein said second equivalence ratio is about 1 and said standby equivalence ratio is greater than 1.

12. The method of claim 11 wherein said standby equivalence ratio is greater than 1.5.

13. The method of claim 2 further comprising pre-heating at least one of said fuel reactant stream and said oxygen-containing reactant stream.

14. The method of 13 wherein at least one of said fuel reactant stream and said oxygen-containing reactant stream is pre-heated by directing it through a heat exchanger coupled to said fuel processor such that heat from said fuel processor is transferred to said reactant stream.

15. The method of claim 1 wherein in step (a), said supply of said fuel reactant stream to said fuel processor is started prior to starting said supply of said oxygen-containing reactant stream to said fuel processor.

16. A method of operating a fuel processor to produce a syngas stream from a fuel reactant stream and an oxygen-containing reactant stream, said method comprising:
(a) supplying said fuel reactant stream and said oxygen-containing reactant stream at an equivalence ratio to said fuel processor to produce said syngas stream;
(b) lowering said equivalence ratio prior to shutting down said fuel processor in order to increase an amount of carbon produced in said syngas stream;
(c) collecting said carbon within said fuel processor;
(d) interrupting supply of said fuel reactant stream and said oxygen-containing reactant stream to said fuel processor to shut-down said fuel processor; and
(e) re-starting said fuel processor to produce said syngas stream,
wherein said carbon collected within said fuel processor is converted to increase syngas output during said re-starting of said fuel processor.

17. The method of claim 16 wherein a particulate filter is employed within said fuel processor to collect said carbon.
